(19) United States
(12) Patent Application Publication
(10) Pub. No.: US 2010/0002805 A1
(43) Pub. Date: Jan. 7, 2010

(54) SIGNAL DECODING SYSTEM AND METHOD

(75) Inventors: WANG-DING SU, Tu-Cheng (TW); SHEN-CHUN LI, Tu-Cheng (TW); CHI-REN KUO, Tu-Cheng (TW); JUI-HSIUNG HO, Tu-Cheng (TW); HUNG CHAO, Tu-Cheng (TW); HUANG-CHING LU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/253,940

(22) Filed: Oct. 17, 2008

(30) Foreign Application Priority Data
Jul. 1, 2008 (CN) 200810302473.1

(51) Int. Cl. H04L 27/00

(52) U.S. Cl. 375/316

(57) ABSTRACT

A signal decoding system includes a signal acquisition unit, and a decoding unit including a segmenting module and a decoding module; the signal acquisition unit is configured for receiving a data waveform and a clock waveform outputted from one or more electronic devices; the segmenting module is configured for dividing the data waveform and the clock waveform into segments; and the decoding module is configured for decoding each segmented data waveform.

### BACKGROUND

1. Field of the Invention

The present invention relates to signal decoding systems and methods, and particularly to a system and method for decoding signals outputted from electronic devices.

2. Description of Related Art

A signal acquisition device, such as an oscilloscope may be used to decode signals outputted from electronic devices and analyze which electronic device the signals are from. The oscilloscope may be used to present the signals on a screen of the oscilloscope in signal waveforms. Often, technician may manually decode the signals by observing and analyzing the signal waveforms.

However, if many signal waveforms are to be decoded, it becomes difficult for the technician to deal with manually, thereby making the signal decoding inaccurate and inefficient.

What is needed, therefore, is to provide a signal decoding system and method to overcome the above described shortcomings.

### BRIEF DESCRIPTION OF THE DRAWINGS

FIG. 1 is a block diagram of an exemplary embodiment of a signal decoding system;

FIG. 2 is a schematic diagram of signal waveforms presenting on a signal acquisition device;

FIG. 3 is a schematic diagram showing how to decode a segment of data waveform; and

FIG. 4 is a flowchart of an exemplary embodiment of a signal decoding method for implementing the signal decoding system of FIG. 1.

### DETAILED DESCRIPTION

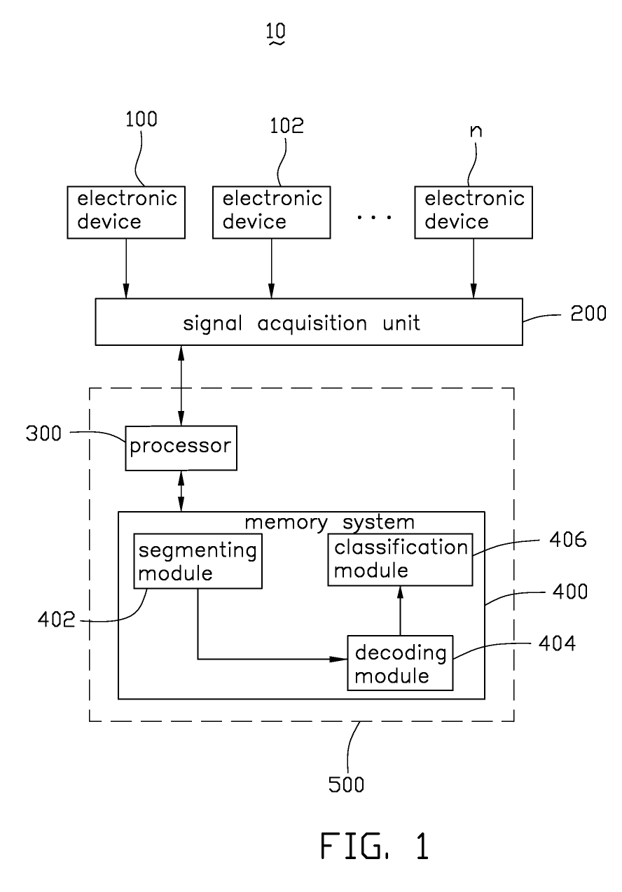

Referring to FIG. 1, an exemplary embodiment of a signal decoding system 10 includes a plurality of electronic devices 100,102 . . . n, a signal acquisition unit 200, and a decoding unit 500. The signal acquisition unit 200 is configured for receiving signals outputted from the electronic devices 100,102 . . . n, and for sending the signals to the decoding unit 500 to be decoded. In one embodiment, the signal acquisition unit 200 may be a signal acquisition device, such as an oscilloscope, but the disclosure is not limited thereto. The signals outputted from the electronic devices 100,102 . . . n are displayed on a screen of the oscilloscope in signal waveforms.

The decoding unit 500 includes a processor 300 and a memory system 400. A segmenting module 402, a decoding module 404, and a classification module 406 are stored in the memory system 400. The processor 300 executes the segmenting module 402, the decoding module 404, and the classification module 406. The processor 300 and the memory system 400 may belong to a computer system or the signal acquisition unit 200 depending on the embodiment.

The segmenting module 402 is configured for dividing the signal waveforms displayed on the screen of the signal acquisition unit 200 into predetermined or selected segments. Each segment includes a start position and an end position.

The decoding module 404 is configured for decoding the segmented signal waveforms. The classification module 406 is configured for comparing the indicating address of the decoded signal waveforms with an electronic device address list pre-stored in the classification module 406, and for determining which electronic device the decoded signal waveforms are from. If the indicating address of the decoded signal waveform is equal to one electronic device address of the address list, the signal is determined to come from the electronic device, the signals are classified by the electronic device address.

The following depicts how the segmenting module 402 performs the segment division for the signal waveforms.

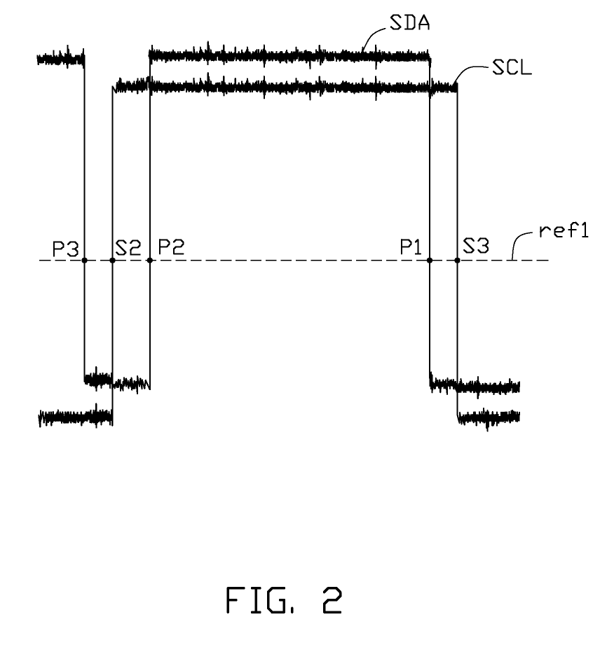

Referring to FIG. 2, signal waveforms are displayed on the screen of the signal acquisition unit 200. Each signal waveform includes a clock waveform SCL and a data waveform SDA. A reference line ref1 intersects the clock waveform SCL at two points S2 and S3, and intersects the data waveform SDA at three points P1, P2, and P3. The points P1, P2, and P3 are all turning points where turnovers (i.e., an inflection point) of the data waveform SDA happen. The direction change of the data waveform SDA is the same at points P1 and P3, and the direction change of the data waveform SDA at point P2 is opposite to that at the points P1 and P3. The points S2 and S3 are turning points of the clock waveform SCL where direction changes are opposite. The direction change of the clock waveform SCL at point S3 is the same as that at points P1 and P3 of the dada waveform SDA. If point P1 of the data waveform SDA is located between the two adjacent points S2 and S3 of the clock waveform SCL as shown in FIG. 2, the point P1 is regarded as a start position of a segment of data waveform SDA, the point S3 is a start position of a segment of the clock waveform SCL, the point P2 is an end position of a previous segment of the data waveform SDA and the point S2 is an end position of a previous segment of the clock waveform SCL. Moreover, a start position and an end position of each segment of the data waveform SDA have the opposite direction change, and a start position and an end position of each segment of the clock waveform SCL have the opposite direction change. As a result, start position and end position of each segment of the data waveform SDA and clock waveform SCL can be determined.

After determining the start position and end position of each segment of the data waveform SDA and clock waveform SCL, the data waveform SDA and clock waveform SCL can be divided into segments and the segmented data waveform SDA can be decoded. The following depicts how to decode and classify the data waveform SDA by the decoding module 404 and the classification module 406.

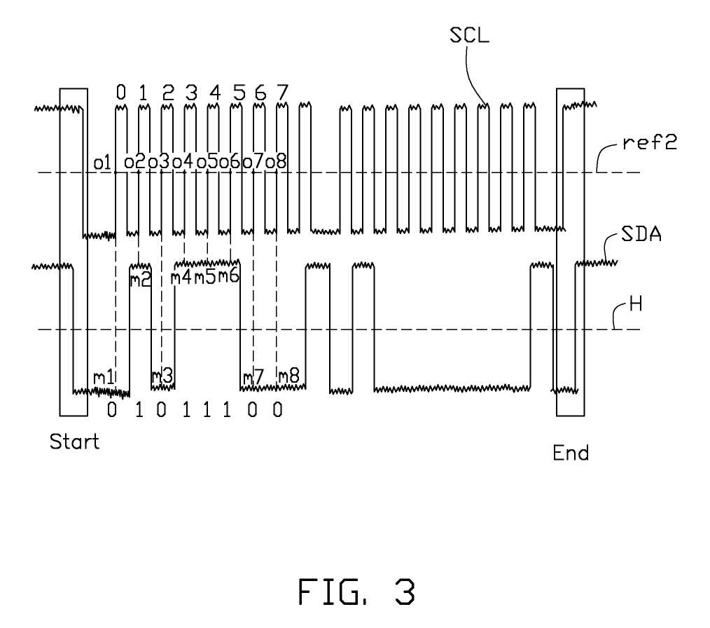

Referring to FIG. 3, a segment of the data waveform SDA and the clock waveform SCL are shown. In order to be clear, the data waveform SDA and the clock waveform SCL are arranged separately. A reference line ref2 intersects the clock waveform SCL at eight points o1-o8 which are eight clock bits, vertical lines are drawn from the points o1-o8 under the same horizontal coordinate to intersect the data waveform SDA at eight points m1-m8 which are eight data bits. On the assumption that following the start position of this segment of the data waveform SDA are seven address bits and a read/write bit, that is to say, the eight bits include the seven address bits m1-m7 and the read/write bit m8. The following depicts the process of decoding the eight bits by the decoding module 404. If longitudinal coordinate values of the data bits are higher than a dividing line H whose longitudinal coordinate indicates a default value, the data bits are decoded as “1”; if less than the default value, the data bits are decoded as “0”, thus the decoding module 404 decodes the eight data bits “01011100” as shown in FIG. 3. The classification module 406 compares the decoded data bits m1-m7 “0101110” denoting the address of the electronic device with the electronic device address list pre-stored in the classification module 406 to determine which electronic device the decoded signal waveform is from.

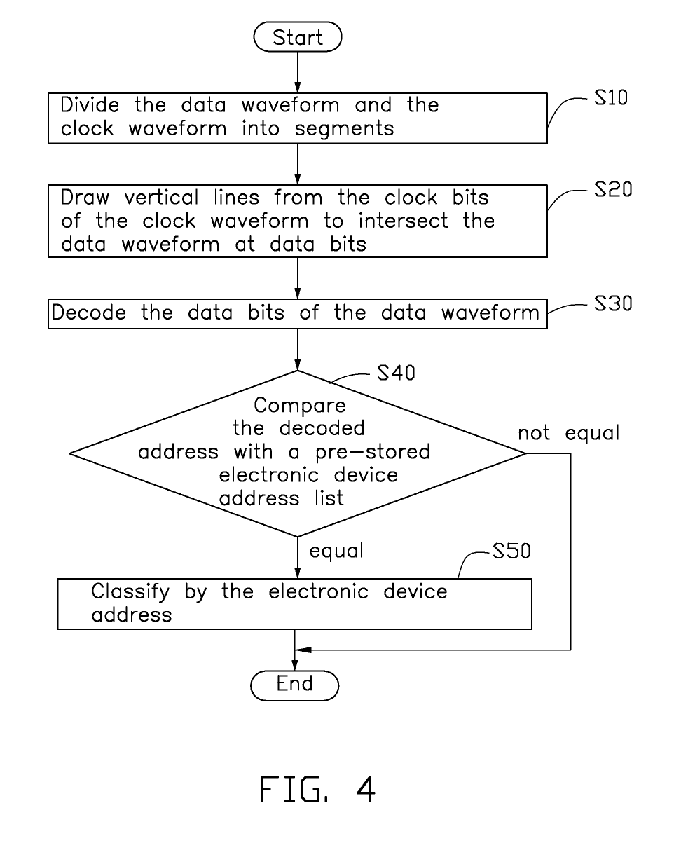

Referring to FIG. 4, an exemplary embodiment of a signal decoding method for implementing the signal decoding system of FIG. 1 includes the following steps described below. Depending on the embodiment, certain of steps described below may be removed, others may be added, and the sequence of steps may be altered.

In step S10, the segmenting module 402 divides the data waveform SDA and the clock waveform SCL into segments. If a point of the data waveform SDA is located between the two adjacent points of the clock waveform SCL, the two adjacent points are turning points of the clock waveform SCL in opposite directions, and the point is regarded as the start position of a segment of the data waveform SDA. One of the two adjacent points of the clock waveform SCL which direction change is the same as the start position of the data waveform SDA is the start position of a segment of the clock waveform SCL. The previous point which is adjacent with the start position of the segment of the data waveform SDA and the direction change is opposite to the start poison of the segment of the data waveform SDA is the end position of the previous segment of the data waveform SDA. The previous point which is adjacent with the start position of the segment of the data waveform SCL and the direction change is opposite to the start poison of the segment of the data waveform SCL is the end position of the previous segment of the data waveform SCL.

In step S20, the decoding module 404 draws vertical lines from the clock bits of each segment of the clock waveform SCL to intersect data waveform SDA at data bits under the same horizontal coordinate.

In step S30, if longitudinal coordinate values of the data bits are higher than the default value, the data bits are decoded as “1”; if less than the default value, the data bits are decoded as “0”.

In step S40, the classification module 406 compares the decoded data bits denoting the address of the electronic device with a pre-stored electronic device address list. If the decoded indicating address of the electronic device is not equal to one of the electronic device addresses of the address list, the procedure goes to the end;

In step S50, if the decoded indicating address of the electronic device is equal to one of the electronic device address of the address list, the signal is determined to come from the electronic device, and the signals are classified by the electronic device address.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A signal decoding system comprising:
a signal acquisition unit configured for receiving a data waveform and a clock waveform outputted from one or more electronic devices, wherein the data waveform and the clock waveform comprises a plurality of points; and
a decoding unit comprising:
a segmenting module configured for dividing the data waveform and the clock waveform into segments upon a condition that a point of the data waveform is located between two adjacent points of the clock waveform, wherein the two adjacent points are turning points of the clock waveform in opposite directions; the point is the start position of a segment of the data waveform, one of the two adjacent points of the clock waveform which direction change is the same as the start position of the data waveform is the start position of a segment of the clock waveform, the end position of a segment of the data waveform and clock waveform have the opposite direction changes of the waveform as the start position; and
a decoding module configured for drawing vertical lines from clock bits of each segment of the clock waveform to intersect the data waveform at data bits under the same horizontal coordinate, and determining encoding of the data bits by comparing longitudinal coordinate values of the data bits with a default value.

2. The system of claim 1, wherein upon a condition that the longitudinal coordinate values of the data bits of the data waveform are higher than a default value, the data bits are decoded as “1”; upon a condition that the longitudinal coordinate values of the data bits of the data waveform are less than the default value, the data bits are decoded as “0”.

3. The system of claim 2, wherein the decoding unit further comprises a classification module configured for comparing the indicating address of the decoded data waveform with an electronic device address list pre-stored in the classification module, and determining which electronic devices the decoded data waveform is from; upon a condition that the indicating address of the decoded data waveform is equal to one of the electronic device address of the address list, the data waveform is determined to come from the electronic device, and the data waveforms are classified by the electronic device address.

4. The system of claim 3, wherein the decoding unit further comprises a processor and a memory system; the segmenting module, the decoding module and the classification module are stored in the memory system; and the processor and the memory system belong to a computer system or the signal acquisition unit.

5. The system of claim 1, wherein the signal acquisition unit is an oscilloscope, and the signal waveforms outputted from the electronic devices are displayed on a screen of the oscilloscope.

6. A signal decoding method comprising:
receiving a data waveform and a clock waveform, wherein the data waveform and the clock waveform comprises a plurality of points;
dividing the data waveform and the clock waveform into segments upon a condition that a point of the data waveform is located between the two adjacent points of the clock waveform, wherein the two adjacent points are turning points of the clock waveform in opposite directions; the point is the start position of a segment of the data waveform, one of the two adjacent points of the clock waveform which direction change is the same as the start position of the data waveform is the start position of a segment of the clock waveform, the end position of a segment of the data waveform and clock waveform have the opposite direction changes of the waveform as the start position;
drawing vertical lines from clock bits of each segment of the clock waveform to intersect the data waveform at data bits under the same horizontal coordinate;
upon a condition that longitudinal coordinate values of the data bits are higher than a default value, the data bits are decoded as “1”, upon a condition that longitudinal coordinate values of the data bits less than the default value, the data bits are decoded as “0”.

7. The method of claim 6, further comprising: comparing the indicating address of the decoded data waveforms with a pre-stored electronic device address list, and determining which electronic devices the decoded data waveforms are from, upon a condition that the indicating address of the decoded data waveform is equal to one of the electronic device address of the address list, the data waveform is determined to come from the electronic device, and the data waveforms are classified by the electronic device address.

8. The method of claim 6, further comprising: displaying the data waveform and the clock waveform outputted from the electronic devices on a screen of an oscilloscope.
